(19) United States
(12) Patent Application Publication
(10) Pub. No.: US 2010/0228483 A1
(43) Pub. Date: Sep. 9, 2010

(54) METHOD OF DETECTING GAS IN A FORMATION USING CAPTURE CROSS-SECTION FROM A PULSED NEUTRON DEVICE

(75) Inventor: Brian J. LeCompte, Tomball, TX (US)

Correspondence Address: Mossman, Kumar and Tyler, PC, P.O. Box 421239, Houston, TX, 77242, US

(73) Assignee: BAKER HUGHES INCORPORATED, Houston, TX (US)

(21) Appl. No.: 12/715,998

(22) Filed: Mar. 2, 2010

Related U.S. Application Data
(60) Provisional application No. 61/157,078, filed on Mar. 3, 2009.

(51) Int. Cl. G01V 5/10; G06F 19/00

(52) U.S. Cl. 702/8; 250/254; 250/269.6; 250/269.1

(57) ABSTRACT

Elemental analysis of an earth formation is performed using measurements from a gamma ray logging tool. From the elemental analysis, an estimate of the mineralogy of the formation is made. A prediction of the capture cross-section of the formation is made using the mineralogical analysis. The difference between the predicted capture cross-section and a measured capture cross-section is an indication of gas in the formation.

### CROSS-REFERENCES TO RELATED APPLICATIONS

This application claims priority from U.S. Provisional Patent Application Ser. No. 61/157,078 filed on 3 Mar. 2009.

### BACKGROUND OF THE DISCLOSURE

1. Field of the Disclosure

The present disclosure is in the field of gamma ray testing of geological formations. In particular, the disclosure determines the presence of gas in a formation from nuclear measurements made in a borehole.

2. Description of the Related Art

Well logging systems have been utilized in hydrocarbon exploration for many years. Such systems provide data for use by geologists and petroleum engineers in making many determinations pertinent to hydrocarbon exploration. In particular, these systems provide data for subsurface structural mapping, defining the lithology of subsurface formations, identifying hydrocarbon-productive zones, and interpreting reservoir characteristics and contents. Many types of well logging systems exist which measure different formation parameters such as conductivity, travel time of acoustic waves within the formation, and the like.

One class of systems seeks to measure incidence of nuclear particles on the well logging tool from the formation for purposes well known in the art. These systems take various forms, including those measuring natural gamma rays from the formation. Still other systems measure gamma rays in the formation caused by bursts of neutrons into the formation by a neutron source carried by the tool and pulsed at a preselected interval.

In these nuclear well logging systems, reliance is made upon the physical phenomenon that the energies of gamma rays given off by nuclei resulting from natural radioactive decay or induced nuclear radiation are indicative of the presence of certain elements within the formation. In other words, formation elements will react in predictable ways, for example, when high-energy neutrons on the order of 14.2 MeV collide with the nuclei of the formation elements. Different elements in the formation may thus be identified from characteristic gamma ray energy levels released as a result of this neutron bombardment. Thus, the number of gamma rays at each energy level will be functionally related to the quantity of each element present in the formation, such as the element carbon, which is present in hydrocarbons. The presence of gamma rays at a 2.2 MeV energy level may for example, indicate the presence of hydrogen, whereas predominance of gamma rays having energy levels of 4.43 MeV and 6.13 MeV, for example, may indicate the presence of carbon and oxygen respectively.

In these nuclear well logging systems, it is frequently useful to obtain data regarding the time spectral distributions of the occurrence of the gamma rays. Such data can yield extremely valuable information about the formation, such as identification of lithologies that are potentially-hydrocarbon producing. Moreover, these desired spectral data may not only be limited to that of natural gamma rays, for example, but also may be desired for the gamma ray spectra caused by bombardment of the formation with the aforementioned pulsed neutron sources.

Well logging systems for measuring neutron absorption in a formation use a pulsed neutron source providing bursts of very fast, high-energy neutrons. Pulsing the neutron source permits the measurement of the macroscopic thermal neutron absorption capture cross-section Σ of a formation. The capture cross-section of a reservoir rock is indicative of its lithology, porosity, formation water salinity, and the quantity and type of hydrocarbons contained in the pore spaces.

The measurement of neutron population decay rate is made cyclically. The neutron source is pulsed for 20-40 microseconds to create a neutron population. Neutrons leaving the pulsed source interact with the surrounding environment and are slowed down. In a well logging environment, collisions between the neutrons and the surrounding fluid and formation atoms act to slow these neutrons. Such collisions may impart sufficient energy to these atoms to leave them in an excited state, from which, after a short time, gamma rays are emitted as the atom returns to a stable state. Such emitted gamma rays are labeled inelastic gamma rays. As the neutrons are slowed to the thermal state, they may be captured by atoms in the surrounding matter. Atoms capturing such neutrons may be caused to be in an excited state, and, after a short time, gamma rays may be emitted as the atom returns to a stable state. Gamma rays emitted due to this neutron capture reaction are labeled capture gamma rays. In wireline well logging operations, as the neutron source is pulsed and the measurements made, the subsurface well logging instrument is continuously pulled up through the borehole. This makes it possible to evaluate formation characteristics over a range of depths.

Depending on the material composition of the earth formations proximal to the instrument, the thermal neutrons can be absorbed, or “captured”, at various rates by certain types of atomic nuclei in the earth formations. When one of these atomic nuclei captures a thermal neutron, it emits a gamma ray, which is referred to as a “capture gamma ray”.

Prior art methods exist for determining gas saturation of a formation generally rely on making measurements of formation density. This requires the use of at least two gamma ray detectors, and three detectors for measurements made in a cased hole. The present disclosure addresses the problem of gas saturation without making estimates of density.

### SUMMARY OF THE DISCLOSURE

One embodiment of the disclosure is a method of determining a presence of gas in an earth formation. The method includes: determining the presence of gas in an earth formation using a difference between an estimated capture cross-section of the earth formation and a predicted capture cross-section of the earth formation, wherein the estimated capture cross-section is estimated by a processor.

Another embodiment of the disclosure is an apparatus configured to determine the presence of gas in an earth formation. The apparatus includes: a source configured to be conveyed in a borehole and irradiate the earth formation; at least one detector configured to measure radiation resulting from the irradiation of the earth formation; and at least one processor configured to: (i) use the measured gamma rays to estimate a capture cross-section of the earth formation; and (ii) use a difference between the estimated capture cross-section and a predicted capture cross-section of the earth formation based on an estimated composition of the earth formation as an indication of the presence of gas.

Another embodiment of the disclosure is a computer-readable medium accessible to at least one processor. The computer-readable medium includes instructions which enable the at least one processor to: use radiation measured by a detector responsive to irradiation of the formation by a source of irradiation in a borehole to estimate a capture cross-section of the formation; and use a difference between the estimated capture cross-section and a predicted capture cross-section of the earth formation based on an estimated composition of the earth formation as an indication of the presence of gas.

### BRIEF DESCRIPTION OF THE DRAWINGS

The present disclosure is best understood with reference to the accompanying figures in which like numerals refer to like elements and in which like numerals refer to like elements and in which:

FIG. 1 (Prior Art) illustrates a nuclear well logging configuration according to one embodiment of the present disclosure;

FIG. 2 shows an instrument suitable for use with an embodiment of the present disclosure;

FIG. 3 is a flow chart illustrating some of the steps of one embodiment according to the present disclosure;

FIG. 4 shows the pulse timing of the pulsed neutron source and the produced gamma rays;

FIG. 5A shows capture decay measured after 950 pulses used for formation Σ measurements with fresh water in the borehole;

FIG. 5B shows capture decay measured after 950 pulses used for formation Σ measurements with 193,000 ppm brine in the borehole; and

FIG. 6 shows a representation of the sum of capture counts for lab values of Σ measurements made with an open-hole pulsed neutron device and measurements made with a cased hole pulsed neutron tool.

### DETAILED DESCRIPTION OF THE DISCLOSURE

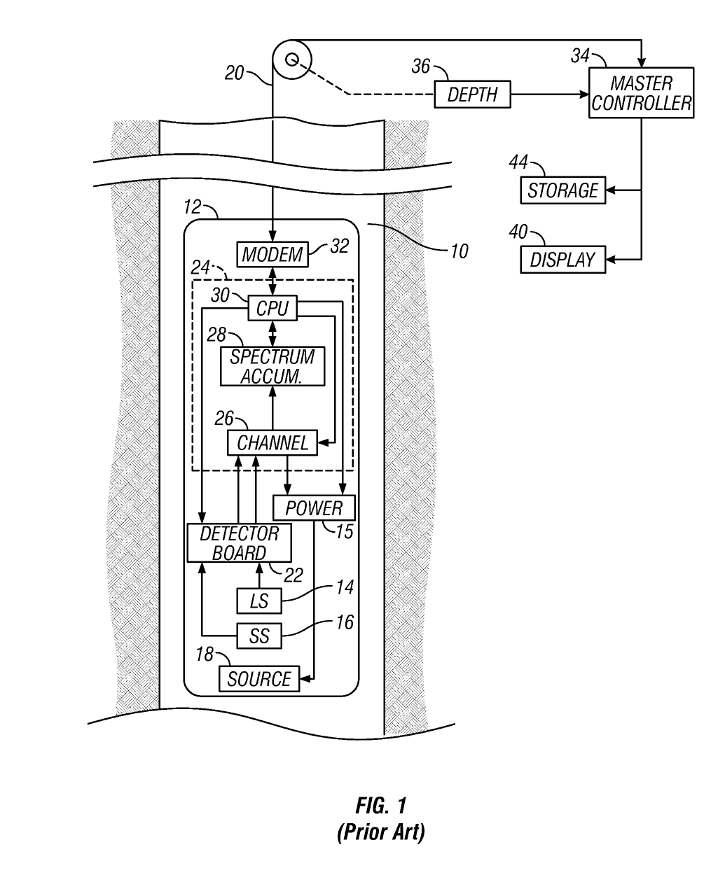

Referring now to the drawings in more detail, and particularly to FIG. 1, there is illustrated a nuclear well logging configuration in accordance with the present disclosure. Well 10 penetrates the earth's surface and may or may not be cased depending upon the particular well being investigated. Disposed within well 10 is subsurface well logging instrument 12. The system diagramed in FIG. 1 is a microprocessor-based nuclear well logging system using multi-channel scale analysis for determining the timing distributions of the detected gamma rays. Well logging instrument 12 includes long-spaced (LS) detector 14, short-spaced (SS) detector 16 and pulsed neutron source 18. In an exemplary embodiment, LS and SS detectors 14 and 16 are comprised of bismuth-germanate (BGO) crystals coupled to photomultiplier tubes. To protect the detector systems from the high temperatures encountered in boreholes, the detector system may be mounted in a Dewar-type flask. Also, in an exemplary embodiment, source 18 comprises a pulsed neutron source using a D-T reaction wherein deuterium ions are accelerated into a tritium target, thereby generating neutrons having an energy of approximately 14 MeV. The filament current and accelerator voltage are supplied to source 18 through power supply 15. Cable 20 suspends instrument 12 in well 10 and contains the required conductors for electrically connecting instrument 12 with the surface apparatus.

The outputs from LS and SS detectors 14 and 16 are coupled to detector board 22, which amplifies these outputs and compares them to an adjustable discriminator level for passage to channel generator 26. Channel generator 26 converts the output pulse heights to digital values, which are accumulated into pulse height spectra, in which the pulses are sorted according to their amplitudes into a discrete array of bins. The bins uniformly divide the entire amplitude range. These pulse height spectra are accumulated in registers in the spectrum accumulator 28, the spectra being sorted according to their type: inelastic, capture, or background. After a pulse height spectrum has been accumulated, CPU 30 controls the transfer of the accumulated data to the modem 32, which is coupled to cable 20 for transmission of the data over a communication link to the surface apparatus. To be explained later are further functions of CPU 30 in communicating control commands which define certain operational parameters of instrument 12 including the discriminator levels of detector board 22, and the filament current and accelerator voltage supplied to source 18 by power supply 15. Channel generator 26, spectrum accumulator 28, and CPU 30 are components in the MCS section 24 of tool 12.

The surface apparatus includes master controller 34 coupled to cable 20 for recovery of data from instrument 12 and for transmitting command signals to instrument 12. There is also associated with the surface apparatus depth controller 36 which provides signals to master controller 34 indicating the movement of instrument 12 within well 10. An input terminal may be coupled to master controller or processor 34 to allow the system operator to provide selected input into master controller 34 for the logging operation to be performed by the system. Display unit 40, and storage unit 44 coupled to the master controller 34 may be provided. The data may also be sent by a link to a remote location. Processing may be done either by the surface processor, at the remote site, or by a downhole processor.

In a well logging operation such as is illustrated by FIG. 1, master controller 34 initially transmits system operation programs and command signals to be implemented by CPU 30, such programs and signals being related to the particular well logging operation. Instrument 12 is then caused to traverse well 10 in a conventional manner, with source 18 being pulsed in response to synchronization signals from channel generator 26. Typically, source 18 is pulsed at a rate of 10,000 bursts/second (10 kHz). This, in turn, causes a burst of high-energy neutrons on the order of 14 MeV to be introduced into the surrounding formation to be investigated. In a manner previously described, this population of high energy neutrons introduced into the formation will cause the generation of gamma rays within the formation which at various times will impinge on LS and SS detectors 14 and 16. As each gamma ray thus impinges upon the crystal-photomultiplier tube arrangement of the detectors, a voltage pulse having an amplitude functionally related to the energy of the particular gamma ray is delivered to detector board 22. It will be recalled that detector board 22 amplifies each pulse and compares them to an adjustable discriminator level, typically set at a value corresponding to approximately 100 keV. If such pulse has an amplitude corresponding to an energy of at least approximately 100 keV, the voltage pulse is transformed into a digital signal and passed to channel generator 26 of MCS section 24.

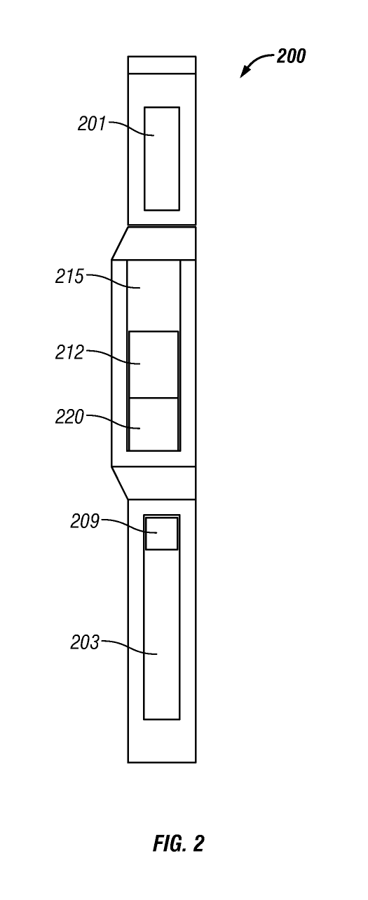

FIG. 2 illustrates a schematic diagram of an instrument suitable for use with the present disclosure. This is a wireline instrument designed to provide formation mineralogical information, shale identification, and clay typing. The enhanced mineralogical data obtained from the FLEX^{SM} also enables enhanced porosity measurements. The present disclosure is usable in open-hole wireline logging. The logging speed is dependent upon the environment. A typical logging speed is in the range of 5-15 ft/min.

The measurement device of FIG. 2 employs the principle of neutron-induced gamma ray spectroscopy. The component parts are encapsulated within wireline device casing 200. The neutron source of the present disclosure is typically a pulsed neutron source. The use of a pulsed neutron source is advantageous over the use of a chemical neutron source due to its ability to operate over a broader range of frequencies. This may be a tritium-deuterium source. Neutron source 209 discharges high-energy bursts of neutrons into the surrounding formation. Gamma rays produced via interaction of the discharged neutrons and the formation are detected at the scintillation detector 212 attached to acquisition and telemetry electronics 215. Power supply 201 enables the device. Electronics 203 enables the neutron source 209. A neutron shield 220 attenuates the neutron flux propagating directly from the source 209 to the detector 212. One embodiment of this pulse scheme uses a pulse during a 30 μs window, a 10 μs wait time, and measures the capture spectrum over 40 μs. This cycle repeats 950 times. The next 1000 μs, equivalent to the length of 50 pulses, are used to measure a capture decay spectrum used for determining the formation sigma.

The present disclosure is based on the fact that every element in the universe has a unique microscopic capture cross-section, referred to as Σᵢ, which is a function of its atomic mass, density, and other inherent properties. Minerals in the earth formations are, for the purposes of this disclosure, considered to be assemblages of elements with a fixed chemical formula and known densities and Σ values. The Σ of a subsurface formation is the volumetrically weighted sum of the Σᵢ of each of its component minerals and any additional pore fluids.

$$\sum = {\sum }_{i = 1}^{n} {V}_{i} * {Σ}_{i} . \qquad ( 1 )$$

In a system where the chemistry of the formation is measured independently of the mineralogy then eqn. (1) can be applied where the Σ of each element is used instead of the mineral.

Subsurface formations are comprised of matrix components such as minerals and some amount of fluid-filled pore space. Several fluids such as gas, water, or oil can fill the pore spaces of a formation. The Σ of water and oil is nearly the same, about 22.4 c.u. The Σ of methane, however, can vary from 22.4 to almost 0 depending on the pressure. For many formations the Σ of the pore-filling gas is usually at least ½ the Σ of water or more if the water contains a large amount of chlorine. This means that formations with water or oil filled pores can be easily distinguished from formations with gas-filled pores by looking at the different Σ values. Historically Σ measurements have been used in cased-hole logging to determine the gas saturation in-situ and to see the depletion of gas over time.

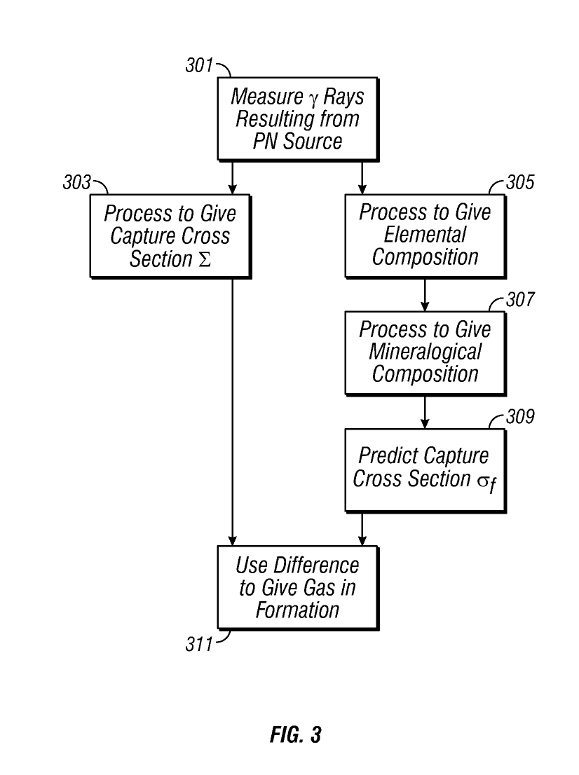

The basic principles of the present disclosure are summarized in the flow chart of FIG. 3. Measurements of gamma rays resulting from a pulsed neutron source are made 301 using a logging tool in a borehole. The measurements are processed to give a capture cross-section Σ_{f} of the formation 303. A prior art method for estimating the capture cross-section is disclosed in U.S. Pat. No. 7,439,494 to Gilchrist et al., having the same assignee as the present disclosure and the contents of which are incorporated herein by reference. The present disclosure provides an alternate method to that taught in Gilchrist for estimating the cross section. This is discussed further below.

In the present disclosure, the gamma ray measurements are also processed to give an elemental composition of the earth formation 305 and a mineralogical analysis of the earth formation 307. The method used may be that disclosed in U.S. Pat. No. 7,205,535 to Madigan et al., having the same assignee as the present disclosure and the contents of which are incorporated herein by reference. Disclosed therein is a method and apparatus of elemental analysis of an earth formation using measurements from a gamma ray logging tool. From the elemental analysis, an estimate of the mineralogy of the formation is made treating the problem as one of Linear Programming (maximizing an objective function subject to equality and/or inequality constraints).

In the present disclosure, using the results of the mineralogical analysis, a prediction is made 309 of the capture cross section Σ of the formation using eqn. (1). The difference between the predicted capture cross-section Σ and the measured capture cross section Σ_{f} is used to give an estimate of the gas in the formation 311.

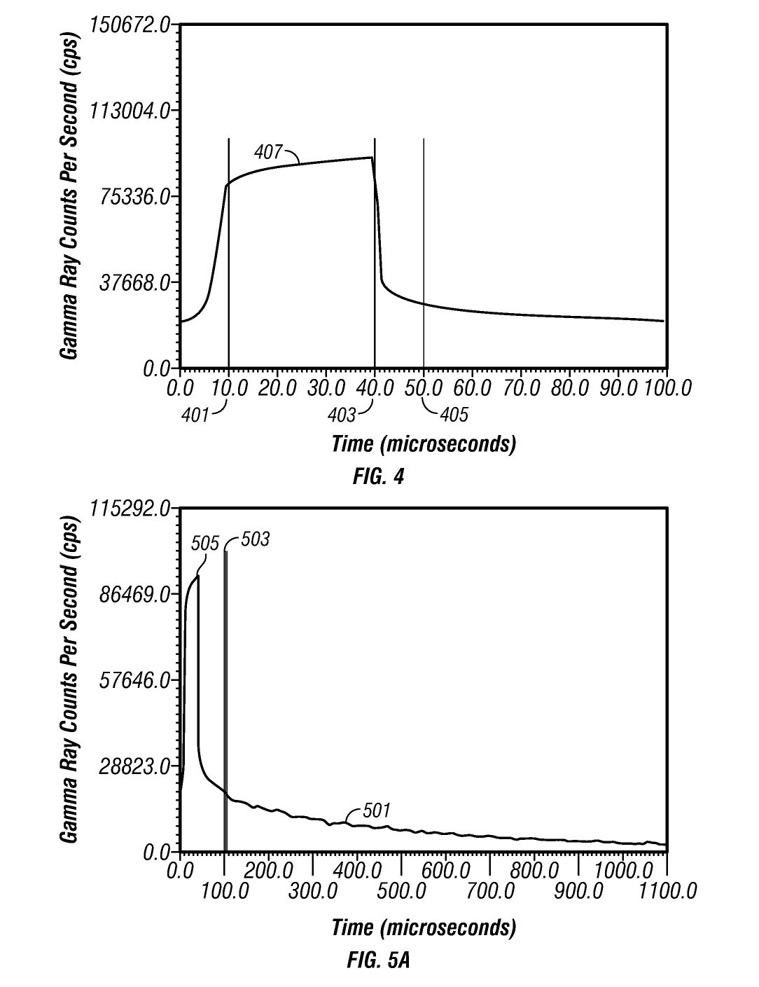

FIG. 4 illustrates the basic timing of the pulsed neutron source and the produced gamma rays. A count of produced gamma rays over time may be displayed as a gamma ray count curve 407. A tritium-deuterium source is activated at time 401 and high energy neutrons are sent into the borehole and formation. These neutrons produce gamma rays as they interact with the nuclei of the native atoms in the neutron cloud both from elastic and inelastic collisions. The inelastic gamma rays are measured during a sequence of pulses while the source continues to fire. Capture gamma rays are also recorded during this time. Later the source is turned off 403 and a spectrum of gamma rays from capture interactions only is measured after time 405. This capture spectrum during the bursts can be modeled from the capture spectrum during the later time gate. One embodiment of this pulse scheme uses a pulse during a 30 μs window from 401-403, a 10 μs wait time from 403-405, then the capture spectrum is measured from 405. This cycle repeats 950 times. The next 1000 μs, equivalent to the length of 50 pulses, are used to measure a capture decay spectrum used for determining the formation sigma.

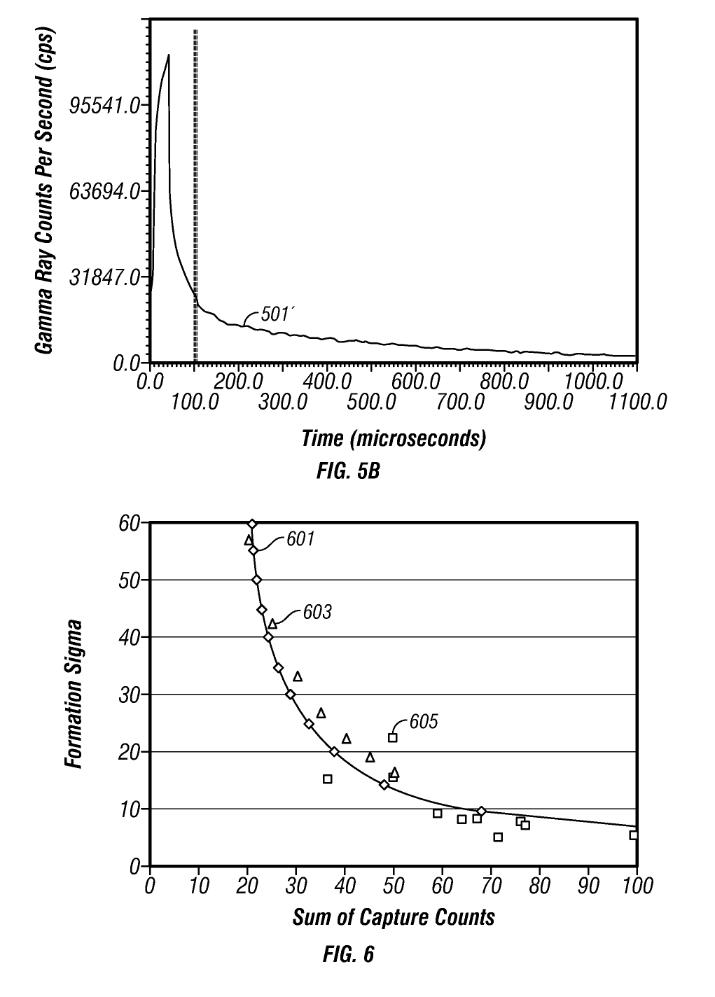

After the exemplary 950 cycles of the sequence shown in FIG. 4, the capture decay is used for estimating the formation cross-section Σ 303. FIG. 5A shows an example of such a decay signal 501. Prior art methods have fit a pair of exponentials to the signal 501 over a time interval starting at 505. One of the exponentials characterizes the cross section of the fluids in the borehole and the second one characterizes the cross section of the formation. To illustrate the effects of the borehole fluids, FIG. 5B shows the decay signal 501′ when the borehole is filled with NaCl at a concentration of 193,000 parts per million. In the present disclosure, instead of dealing with a decay signal that could be affected by borehole fluids, only the latter part of the decay signal (after time 503) is used for estimating the formation cross-section.

The sigma of the formation can be understood then as a function of the neutron population at any given time.

$$N = {N}_{0} {e}^{\frac{- {Σ}_{f} t}{4550}} , \qquad ( 2 )$$

where Σ_{f} is the formation sigma, t and N is the number of neutrons at any time t. For many pulsed neutron capture logging devices there is an assumption that the number of gamma rays produced is proportional to the number of neutrons.

$$G = {G}_{0} {e}^{\frac{- {Σ}_{f} * t}{a}} . \qquad ( 3 )$$

Eqn. (3) can then solved for Σ_{f} analytically or it can be determined from the integral of G with respect to t over a fixed time interval, for example 1000 μs.

$${\int }_{0}^{1000} G ( t ) d t = \frac{A}{{Σ}_{f}} ( {e}^{{Σ}_{f} B} - 1 ) = S . \qquad ( 4 )$$

Where A and B are constants of integration dependent upon the initial gamma ray population and the time of integration, both of which are fixed values in this method, and S is the sum of the counts. The initial gamma ray population can be considered a fixed number because of a feedback loop in the FLEX^{SM} processing system. This loop consists of measuring the gamma ray counts at every record during the logging pass. If the total gamma ray counts fall above or below a range near 90,000 counts per second (cps) then the FLEX^{SM} tool changes the voltage of its neutron generator by one unit. The gamma ray counts are measured at the new voltage and if they fall within the acceptable range near 90,000 cps then the voltage remains at that value. If it does not then the loop continues until the voltage reaches a value where the cps are close to 90,000. Current neutron generator technology cannot handle rapid changes in motor voltage so a delay in the feedback loop is necessary to ensure a slowly changing motor voltage. The values of the constants may be determined by measurements made in a water tank, a block of limestone, a block of sandstone and or from log data comparisons with measurements made by a logging tool configured to measure the cross section. There is no one analytical solution for Σ_{f} from eqn. (4) but it can be solved with numerical methods. One such solution is given as

Σ_{f}=cS^{d} (5).

where c and d are constants which may depend on the logging environment and borehole sigma. These can be obtained by standard curve-fitting techniques.

FIG. 6 shows a plot of measured formation Σ against the sum of capture counts measured by a pulsed neutron device. The curve 601 and the points on it show eqn. (4). The points 605 are measurements made in a borehole using a pulsed neutron device while the points 603 are for laboratory samples with a high cross section sigma.

Returning now to FIG. 3, we note that as an alternative to using the method described in Madigan, the mineralogical analysis may be one using an expert system as described in U.S. patent application Ser. No. 11/589,374 of Jacobi et al., having the same assignee as the present disclosure and the contents of which are incorporated herein by reference. One point of difference between the method disclosed by Jacobi for getting a mineralogic composition from the method in Madigan is that in Jacobi, lithologic constraints are used. Defining lithologic constraints is an easier step than mineralogic constraints when the objective is, after all, to determine mineralogy.

These determined minerals can be converted to volumes using their known characteristic densities. The Σᵢ of each mineral is then added together to give the total formation Σ. In an alternate embodiment of the disclosure, the estimation of the mineralogic analysis (307 in FIG. 3) is bypassed and the formation Σ is estimated from the elemental analysis 305. The bypassing of the mineralogical analysis is more accurate when trace elements that are not measured in nuclear spectroscopy are not present in the formation.

In many cases the sigma of a given mineral is less than the measured sigma of that mineral in a subsurface formation. This is due to the contribution of trace elements such as Gd, B, Cl, Ti, and others which may not be part of the chemical structure of a mineral but nonetheless are present in trace amounts in the earth formation. These elements often show strong correlations with one another so that if one is known, the concentration of all such elements can be estimated. Thorium provides a good proxy for the trace elements with high capture cross section because it is readily measured by natural spectroscopy methods.

One other way of estimating the trace element contribution is to use the measured sigma from eqn. (5). This has the added benefit that all measurements are made with a single tool. One such way of converting the measured sigma to a trace element contribution is to use a linear interpolation which is normalized for sigma values in the high sigma and low sigma sections of the formation. Clays often contain the highest degree of trace elements with high sigma, but certain evaporites and other formations can also contribute.

$${\sum }_{TE} = \sum * \frac{Σ - {σ}_{max}}{{σ}_{min} - {σ}_{max}} \qquad ( 6 )$$

It should be apparent to one skilled in the art that eqn. (6) is a common method used in petrophysics to scale a measured value between a maximum and minimum, such as in a volume of shale determination. The final sigma is the sum of the calculated sigma and the trace element sigma.

Differences between the formation sigma measured by the pulsed neutron tool and the calculated sigma from the pulsed neutron spectroscopy results are due to differences in porosity and gas content. A highly porous formation with gas-filled pores will have higher gamma count rates and thus a lower sigma. If this formation was a shaly sand, for example, it could have a sigma value of about 25 c.u. If it was filled with gas in 20% porosity the sigma could be as low as 20. The presence of gas in the formation would be indicated by a crossover of a log of measured cross section and a log of the predicted cross section. This is similar to the crossover of neutron porosity logs and density porosity logs that have been noted in the past.

The sigma of the formation is the sum of the sigmas of both the rock matrix and the pore space.

Σ_{f}=Vₘₐₜᵣᵢₓ·Σₘₐₜᵣᵢₓ+Vₚₒᵣₑ·Σₚₒᵣₑ (7)

The sigma of the matrix can be further developed into each mineral component.

$${\sum }_{matrix} = {\sum }_{i = 1}^{n} ( {V}_{min , i} \cdot {Σ}_{min , i} ) , \qquad ( 8 )$$

where V_{min,i} and Σ_{min,i} are the volume fractions and cross sections of the i-th mineral constituent.
The sigma of the pore space is also the sum of each component of the pore space.

Σₚₒᵣₑ=V_{water}·σ_{water}+V_{gas}·σ_{gas}+Vₒᵢₗ·σₒᵢₗ (9).

Combining the above equations leads to the following relationship between formation sigma and porosity.

Σ_{f}=(1−φ)·Σₘₐₜᵣᵢₓ+φ·Σₚₒᵣₑ (10),

and

$$\frac{{\sum }_{f} - {\sum }_{matrix}}{φ} + {\sum }_{matrix} = {\sum }_{pore} . \qquad ( 11 )$$

In situations where the porosity is known or can be reasonably estimated Eqn. (11) gives an estimate of the sigma of the porosity. This value can in turn be used in Eqn. (9) to estimate gas saturation when the water salinity is known and there is only a gas and water mixture in the pore space. When the water salinity is not known a method such as that described by LeCompte et al. in U.S. patent application Ser. No. 12/146,071 can be used to determine it using FLEX chlorine measurements.

In many cases a qualitative gas indicator from logs is desired as a deliverable at the well site either during or immediately after logging. In these cases the capture cross section of the rock matrix computed from mineralogy and the total formation capture cross section measured can be plotted in the same track. In formations where the measured formation sigma is less than the computed matrix sigma, the presence of gas is indicated by shading in the space between the two curves. Since the matrix sigma represents a rock with no porosity, the only possible way to mathematically have a true sigma less than this value is for the formation to have some pores filled with gas which has a low sigma value.

The sigma crossover is a graphical representation of eqn. (11). For example, consider a formation with sigma of the matrix equal to 10 c.u. but the measured sigma reads 9 c.u. From eqn. (11) it is clear that the porosity must be at least 10 pu, since the pore sigma must be greater than 0 and porosity cannot be negative. If 40 pu is considered a likely upper bound in this example then the porosity ranges from 10-40 pu and the sigma of the pore fluid from 0 to 7.5 c.u, which is an indication of gas since the highest likely sigma is still less than 22.4, the sigma of fresh water. The fact that gas and water often differ by one or two orders of magnitude makes the sigma crossover a robust method for the qualitative indication of gas in the formation.

What has been described above includes a method of determining a presence of gas in an earth formation. The method includes: determining the presence of gas in an earth formation using a difference between an estimated capture cross-section of the earth formation and a predicted capture cross-section of the earth formation, wherein the estimated capture cross-section is estimated by a processor. The method may also include: irradiating the earth formation using a source of radiation within a borehole; measuring radiation from the earth formation responsive to the irradiation; and using the measured radiation to estimate the capture cross-section of the earth formation. Irradiating the earth formation may further include using a pulsed neutron source and measuring the radiation further comprises measuring gamma rays resulting from the irradiation. Determining the predicted cross-section may be done using a composition selected from: (i) an elemental composition, and (ii) a mineralogical composition. Determining the composition may be done using an elemental analysis of spectra of the measurements of the radiation. Estimating the capture cross-section of the earth formation may be done by performing a summation of counts of the radiation over a time window substantially unaffected by a fluid in the borehole. The method may further include correcting the predicted cross-section for a trace element. The method may further include identifying the presence of gas by a crossover of a log of the estimated capture cross-section and a log of the predicted cross-section. The method may further include conveying the source of radiation into the borehole on a conveyance device selected from: (i) a wireline, and (ii) a bottomhole assembly on a drilling tubular.

In another aspect, the disclosure covers an apparatus configured to determine a presence of gas in an earth formation. The apparatus includes: a source configured to be conveyed in a borehole and irradiate the earth formation; a detector configured to measure radiation resulting from the irradiation of the earth formation; and at least one processor configured to: use the measured gamma rays to estimate a capture cross-section of the earth formation; and use a difference between the estimated capture cross-section and a predicted capture cross-section of the earth formation based on an estimated composition of the earth formation as an indication of the presence of gas. The source may include a pulsed neutron source and the radiation that the receiver is configured to measure further comprises gamma rays. The at least one processor may be further configured to determine the predicted cross-section using a composition selected from: (i) an elemental composition, and (ii) a mineralogical composition. The at least one processor may be further configured to determine the composition using an elemental analysis of spectra of the measured radiation. The at least one processor may be further configured to estimate the capture cross-section of the earth formation by performing a summation of counts of the radiation over a time window substantially unaffected by a fluid in the borehole. The at least one processor may be further configured to correct the predicted cross-section for a trace element. The at least one processor may be further configured to identify the presence of gas by a crossover of a log of the estimated capture cross-section and a log of the predicted cross-section. The apparatus may further include a conveyance device configured to convey the logging tool into the borehole, the conveyance device being selected from: (i) a wireline, and (ii) a bottomhole assembly on a drilling tubular.

Another aspect of the disclosure is a computer-readable medium accessible to at least one processor. The computer-readable medium includes instructions which enable the at least one processor to: use radiation measured by a detector responsive to irradiation of the formation by a source of irradiation in a borehole to estimate a capture cross-section of the formation; and use a difference between the estimated capture cross-section and a predicted capture cross-section of the earth formation based on an estimated composition of the earth formation as an indication of the presence of gas. The computer-readable medium may include a ROM, an EPROM, an EEPROM, a flash memory, and/or an optical disk.

It should be noted that the description of the method above has been in terms of a logging tool conveyed on a wireline. This is not to be construed as a limitation, and the method may also be practiced using a logging tool that is part of a bottomhole assembly (BHA) conveyed on a drilling tubular.

The processing of the measurements made in wireline applications may be done by the surface processor 34, by a downhole processor 30, or at a remote location. The data acquisition may be controlled at least in part by the downhole electronics. Implicit in the control and processing of the data is the use of a computer program on a suitable machine readable-medium that enables the processors to perform the control and processing. The machine-readable medium may include ROMs, EPROMs, EEPROMs, flash memories and optical disks. The term processor is intended to include devices such as a field programmable gate array (FPGA).

While the foregoing disclosure is directed to the specific embodiments of the disclosure, various modifications will be apparent to those skilled in the art. It is intended that all such variations within the scope and spirit of the appended claims be embraced by the foregoing disclosure.

What is claimed is:

1. A method of determining a presence of gas in an earth formation, the method comprising:
determining the presence of gas in an earth formation using a difference between an estimated capture cross-section of the earth formation and a predicted capture cross-section of the earth formation, wherein the estimated capture cross-section is estimated by a processor.

2. The method of claim 1, further comprising:
irradiating the earth formation using a source of radiation within a borehole;
measuring radiation from the earth formation responsive to the irradiation; and
using the measured radiation to estimate the estimated capture cross-section of the earth formation.

3. The method of claim 2 wherein irradiating the earth formation further comprises using a pulsed neutron source, and measuring the radiation further comprises measuring gamma rays resulting from the irradiation.

4. The method of claim 1 further comprising determining the predicted capture cross-section using a composition selected from: (i) an elemental composition, and (ii) a mineralogical composition.

5. The method of claim 4 further comprising determining the composition using an elemental analysis of spectra of the measurements of the radiation.

6. The method of claim 1 wherein estimating the capture cross-section of the earth formation further comprises performing summation of counts of the radiation over a time window substantially unaffected by a fluid in a borehole.

7. The method of claim 1 further comprising correcting the predicted cross-section for a trace element.

8. The method of claim 1 further comprising identifying the presence of gas by a crossover of a log of the estimated capture cross-section and a log of the predicted capture cross-section.

9. The method of claim 2 further comprising conveying the source of radiation into the borehole on a conveyance device selected from: (i) a wireline, and (ii) a bottomhole assembly on a drilling tubular.

10. An apparatus configured to determine a presence of gas in an earth formation, the apparatus comprising:
a source configured to be conveyed in a borehole and irradiate the earth formation;
a detector configured to measure radiation resulting from the irradiation of the earth formation; and
at least one processor configured to:
(i) use the measured gamma rays to estimate a capture cross-section of the earth formation; and
(ii) use a difference between the estimated capture cross-section and a predicted capture cross-section of the earth formation based on an estimated composition of the earth formation as an indication of the presence of gas.

11. The apparatus of claim 10, wherein the source further comprises a pulsed neutron source, and the radiation that the receiver is configured to measure further comprises gamma rays.

12. The apparatus of claim 10 wherein the at least one processor is further configured to determine the predicted capture cross-section using a composition selected from: (i) an elemental composition, and (ii) a mineralogical composition.

13. The apparatus of claim 12 wherein the at least one processor is further configured to determine the composition using an elemental analysis of spectra of the measured radiation.

14. The apparatus of claim 10 wherein the at least one processor is further configured to estimate the capture cross-section of the earth formation by performing a summation of counts of the radiation over a time window substantially unaffected by a fluid in the borehole.

15. The apparatus of claim 13 wherein the at least one processor is further configured to correct the predicted capture cross-section for a trace element.

16. The apparatus of claim 10 wherein the at least one processor is further configured to identify the presence of gas by a crossover of a log of the estimated capture cross-section and a log of the predicted capture cross-section.

17. The apparatus of claim 10 further comprising a conveyance device configured to convey the logging tool into the borehole, the conveyance device being selected from: (i) a wireline, and (ii) a bottomhole assembly on a drilling tubular.

18. A computer-readable medium accessible to at least one processor, the computer-readable medium including instructions which, when executed, cause the at least one processor to:
estimate a capture cross-section of a formation using radiation measured by a detector responsive to irradiation of the formation by a source of irradiation in a borehole; and
determine the presence of a gas using a difference between the estimated capture cross-section and a predicted capture cross-section of the earth formation and an estimated composition of the earth formation.

19. The medium of claim 18 further comprising at least one of: (i) a ROM, (ii) an EPROM, (iii) an EEPROM, (iv) a flash memory, and (v) an optical disk.
